(19) United States
(12) Patent Application Publication
(10) Pub. No.: US 2020/0258047 A1
(43) Pub. Date: Aug. 13, 2020

(54) SYSTEM AND METHOD FOR ONLINE SALES COMPETITION AND GAME

(71) Applicant: TRANSACTION COMMUNICATIONS, LLC, NORTH PALM BEACH, FL (US)

(72) Inventor: Scott RANDALL, NORTH PALM BEACH, FL (US)

(73) Assignee: TRANSACTION COMMUNICATIONS, LLC

(21) Appl. No.: 16/788,395

(22) Filed: Feb. 12, 2020

Related U.S. Application Data
(60) Provisional application No. 62/804,349, filed on Feb. 12, 2019.

(51) Int. Cl. G06Q 10/10; G06Q 10/06; G06F 40/55; G06N 3/00

(52) U.S. Cl. CPC G06Q 10/1053; G06Q 10/063112; G06N 3/006; G06F 40/55; G06Q 10/06393

(57) ABSTRACT

A system and method matching a potential sales talent, also referred to herein as a player or players, with potential employers based on non-biased indicators, which may include skills based criteria for example. The match is performed through a simulated sales session, which may be implemented as a game. The behavior of the player is scored during the simulated sales session. The game is implemented with AI-driven animated bots and game mechanics to simulate live selling situations and assess player skills in a competitive mobile/PC device experience. The aspects of the disclosed embodiments are configured to use machine learning to leverage data from Players and Employers to make predictive, successful matches between the two parties.

### FIELD

The aspects of the disclosed embodiments are directed to a computer implemented sales competition and in particular, to a system and computer implemented method to execute a sales competition, game and talent marketplace (platform).

### BACKGROUND

Sales are among the most difficult positions to fill, and bad hiring decisions are costly. Companies want new recruits to hit the ground running, but most college graduates enter the job market without sales experience or any way to quantify their skills.

Resumes are not an indication of ability, neither is “personality”. Companies want an indication of a candidate's sales skills before hiring them.

College sales competitions have emerged as a way for companies to address these problems, but the process is imperfect. The competitions are expensive for students and companies alike to attend, the results are inconsistent and the limited nature of live events means limited reach for schools and employers.

### SUMMARY

The background art does not teach or suggest a scaled, digital solution for assessing sales talent's actual selling skills in a realistic environment and matching Players with Employers based on non-biased indicators.

Accordingly, it would be desirable to be able to provide a system and computer implemented method that addresses these drawbacks of the background art.

The aspects of the disclosed embodiments provide a system and method for a scaled, digital solution that assesses the actual selling skills of a potential sales talent in a realistic, yet simulated environment. The system and method of the disclosed embodiments is configured to match a potential sales talent, also referred to herein as a player or players, with potential employers based on non-biased indicators. The aspects of the disclosed embodiments also include a game application that provides a simulated sales session. The game application is one part of the scoring component of the aspect of the disclosed embodiments

According to a first aspect, the disclosed embodiments are configured to use live, real-time, AI-driven animated bots and game mechanics to simulate live selling situations and assess player skills in a competitive mobile/PC device experience. The aspects of the disclosed embodiments are configured to use machine learning to leverage data from Players and Employers to make predictive, successful matches between the two parties.

In one implementation, players get to select a certain or limited number of sales position interviews, for example, to compete for. This keeps players from adopting a “spray and pray” approach and connects companies with serious, targeted and motivated players.

In one implementation, players who complete the competition and achieve a score above a designated threshold are entered to win a cash prize.

These and other aspects, implementation forms, and advantages of the exemplary embodiments will become apparent from the embodiments described herein considered in conjunction with the accompanying drawings. It is to be understood, however, that the description and drawings are designed solely for purposes of illustration and not as a definition of the limits of the disclosed invention, for which reference should be made to the appended claims. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

Although the present invention is described with regard to a “computing device”, a “computer”, or “mobile device”, it should be noted that optionally any device featuring a data processor and the ability to execute one or more instructions may be described as a computer, including but not limited to any type of personal computer (PC), a server, a distributed server, a virtual server, a cloud computing platform, a cellular telephone, an IP telephone, a smartphone, or a PDA (personal digital assistant). Any two or more of such devices in communication with each other may optionally comprise a “network” or a “computer network”.

### BRIEF DESCRIPTION OF THE DRAWINGS

In the following detailed portion of the present disclosure, the invention will be explained in more detail with reference to the example embodiments shown in the drawings, in which:

FIG. 1 illustrates an exemplary process flow incorporating aspects of the disclosed embodiments;

FIG. 2 illustrates an exemplary system architecture incorporating aspects of the disclosed embodiments;

FIG. 3 shows a schematic illustration of an exemplary network-based operating environment incorporating aspects of disclosed embodiments;

FIG. 4 illustrates an exemplary process flow incorporating aspects of the disclosed embodiments;

FIG. 5 illustrates an exemplary spoken language framework for a system incorporating aspects of the disclosed embodiments;

FIG. 6 illustrates an exemplary data flow for a player in a system incorporating aspects of the disclosed embodiments;

FIG. 7 illustrates a video animation frame presented on a computing device for an exemplary meeting implementation incorporating aspects of the disclosed embodiments;

FIG. 8 illustrates an animation presented on a computing device of an exemplary simulated meeting scenario in a system incorporating aspects of the disclosed embodiments;

FIG. 9 provides an exploded view of an exemplary computing device architecture incorporating aspects of the disclosed embodiments; and

FIG. 10 illustrates a schematic diagram of an exemplary computer architecture that can be used to implement one or more of the aspects of the disclosed embodiments.

### DETAILED DESCRIPTION

The aspects of the disclosed embodiments provide a scaled, digital solution for assessing the actual selling skills of a potential sales talent in a realistic, yet simulated environment. The system and method of the disclosed embodiments is configured to match a potential sales talent, also referred to herein as a player or players, with potential employers based on non-biased indicators.

The system of the disclosed embodiments is configured to use one or more of artificial intelligence (AI), performance data, aptitude assessments and machine learning to assess the selling skills of a player in a simulated online selling competition. In one embodiment, players compete in a gamified sales simulation to qualify for interviews for real-world sales jobs. Employers compete to attract these players for real-world positions. The aspects of the disclosed embodiment advantageously provide a practical application of connecting players (the potential sales talent) with employers for job interviews, and in some cases, jobs.

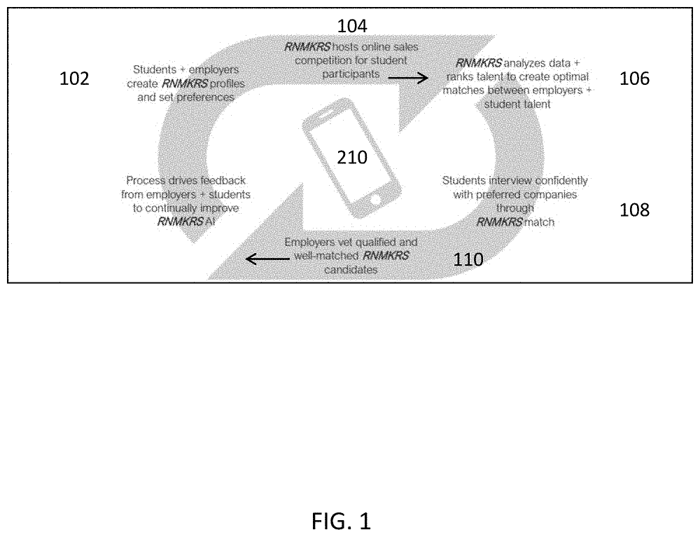

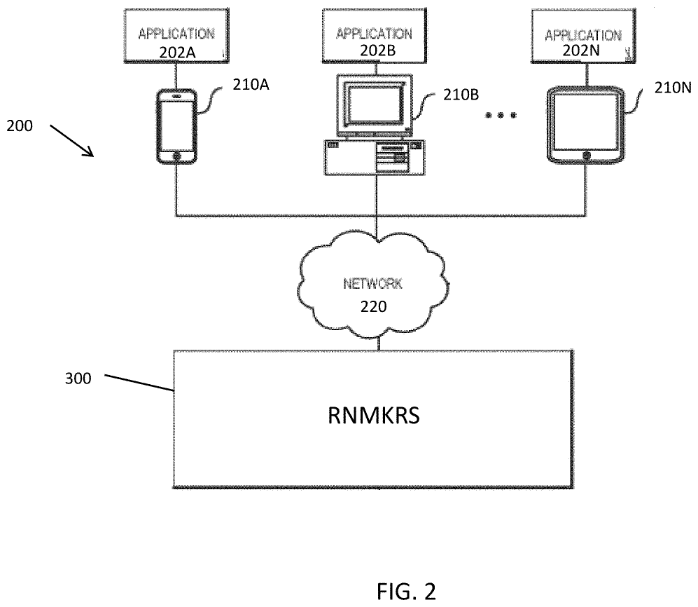

FIG. 1 illustrates an exemplary flow process incorporating aspects of the disclosed embodiments. In this example, in an initial step 102, users, in this example referred to as students and employers, create individual profiles and set preferences. In the example of FIG. 1, the users can make use of a user device 210, shown here as mobile communication device 210, to interact with the application and system. In alternate embodiments, as will be described further herein, the users can use any suitable computing or mobile computing device. The system 200 of the disclosed embodiments, an example of which is illustrated with respect to FIG. 2, is configured to enable the creation and storage of the profiles and preferences, as will be further described herein.

In one embodiment, an online sales competition is hosted 104 for the player participants. The data that is produced from the online sales competition is configured to be analyzed 106 in order to rank the player participant and create optimal matches between employers and the player participants. In one embodiment, player participants are matched 106 with one or more employers. This enables the player participants to interview 108 or connect confidentially with preferred employers, and employers can vet 110 matched candidates.

The aspects of the disclosed embodiments are configured to enable different groups of users to participate in the sales competition. In this example, four groups of users are described. However, the aspects of the disclosed embodiments are not so limited. In alternate embodiments, any suitable number and types of groups of users is contemplated. In one embodiment, the groups of users are generally described as:

(i) Employers: the companies looking for sales talent

(ii) Players: For example, students, professionals or others who are looking for sales jobs, also referred to as potential sales talent. This group can also include players in “white label” custom competitions for paying clients. For example, the aspects of the disclosed embodiments will provide companies the ability to collaborate to develop custom, white label competitions for recruiting or training for their company only, such as by featuring Key Performance Indicators (KPIs) specific to their business. This can include a simulation content development tool specific to the needs of the company.

(iv) Sponsors: advertisers who pay for branded messaging that appears on the platform. In one embodiment, messages may also appear within the sales game application that is described herein.

(v) Affiliate Partners: online services available to players in the pre-game (for example resume companies, behavioral testing companies). In one embodiment, Affiliate Partners will pay or otherwise provide compensation for the Players that are sent their way and/or a percentage of what those Players spend on the Affiliates products or services.

FIG. 2 illustrates one example of a network-based operating environment or system 200 in which some embodiments of the present disclosure may be practiced or implemented. As is illustrated in FIG. 2, the operating environment 200 includes applications 202A-202N or instances thereof, running on respective ones of one or more mobile or computing devices 210A-210N. The aspects of the disclosed embodiments can feature live online, shared competitive digital experiences with multiple players, also referred to as users, participating simultaneously on mobile devices and personal computer devices 210. The participation can take place at any suitable time, such as for example during an appointed day and time slot. In one embodiment, this digital event component is used to build excitement for the brand as well as excitement for verticals (pharma sales events etc), for example. While the aspects of the disclosed embodiments are generally described herein with respect to mobile devices and personal computer devices, the aspects of the disclosed embodiments are not so limited. In alternate embodiments, any suitable computing device or devices can be used that provides a live online, shared competitive digital experiences with multiple players participating simultaneously. For example, the devices can include computing devices, mobile phones, a tablet computer, a mobile media device, a mobile gaming device, a dedicated terminal, a public terminal, a desktop or laptop computer or a kiosk. These computing devices can include mechanisms for receiving, sending and storing information in accordance with the processes described herein.

In the example of FIG. 2, the system 200 of the disclosed embodiments includes a platform 300 of interconnected hardware devices and software configured to exchange data with the goal of matching players with employers. The platform 300 will be generally referred to herein as the RNMKRS system, encompassing a number of components for supporting the functions of the sales simulation as described herein. In one embodiment, the communication to and between the user devices 210A-210N and the platform 300 can take place over a network 220, such as the Internet, for example. In alternate embodiments, any suitable networked environment is anticipated.

In one embodiment, the RNMKRS platform 300 generally includes or is connected to one or more servers, and a Simulation Application. The one or more servers, as will be further described herein, is/are generally configured to archive or store all voice data and will be where the AI software sits, as well as allow Players and Employers to register, input data and connect with each other. In one embodiment, the server(s) are implemented through a cloud based configuration. The Simulation Application portion of the RNMKRS platform 300 is configured to enable Players to demonstrate their sales skills in a realistic, AI-driven digital sales simulation. In one embodiment, the simulation application is configured to reside on the user (client) devices. Instances of the Simulation Application generally comprises the applications 202A-202N referred to in FIG. 2.

The aspects of the disclosed embodiments are generally directed to an AI driven digital sales simulation exercise and competition. While the aspects of the disclosed embodiments will be described herein with reference to sales, the aspects of the disclosed embodiments are not so limited. In alternate embodiments, the system 300 can be implemented for any suitable skill driven situation or activity where players can demonstrate those skills in a realistic, AI-driven skill simulation. For example, other skill-driven solutions incorporating aspects of the disclosed embodiments can include, but are not limited to, customer service relations, trial practice, arbitration.

Users or players engage with the simulation as is generally described herein via an application 202A-202N that is accessed via their device 210A-210N. In one embodiment, the application(s) 202A-202N is software that is downloaded to the respective one or more of the device(s) 210A-210N. In alternate embodiment, the application(s) 202A-202N comprises non-downloadable software that is temporarily accessed by the respective one or more of the devices 210A-210N.

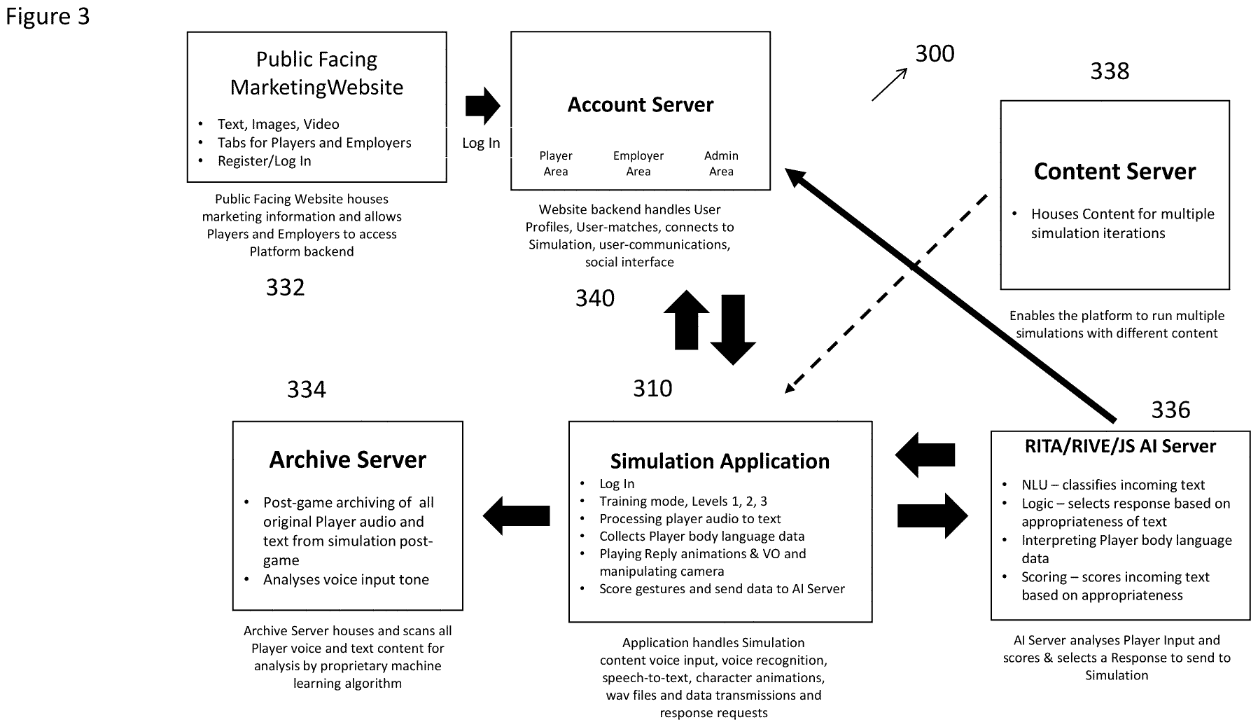

Referring also to FIG. 3, the hardware and software devices of the disclosed embodiments are configured to store and execute software routines that process, collect, analyze and exchange user-input and communications. FIG. 3 illustrates an exemplary overall system architecture incorporating aspects of the disclosed embodiments and describes the function of the different modules and process of disclosed embodiments. The system, also described herein as a platform (for example, in FIG. 2), is also the connection point between the public-facing website, where Players and Employers go to register, with the simulation/game app and the AI Server (where the game scoring and AI software reside).

As shown in FIG. 3, in one embodiment, the RNMKRS platform 300 can generally include four components, a website server 332, an archive server 334, an AI server 336 and a Content Server 338. The website server 332 will generally comprise or provide a public facing marketing web page that will enable Player and Employer Login and Account creation. In one embodiment, the website server 332 can include or be connected to an account server 340 that will interface with the Simulation Application 310, and be configured to provide, among other things, Profile Creation and hosting, Leaderboards, Matching, User communications and a Social Interface.

In one embodiment, the Archive Server 334 is generally configured to save all player input, including voice, text and any multimedia or video. The archive server 334 can be configured to use proprietary machine learning algorithm(s) to scan saved data to optimize matches and train the AI Server 336.

The AI Server 336 is configured to receive player input, such as text, voice and camera or video images. In one embodiment the AI Server 336 includes Natural Language Understanding (NLU) that is configured to classify incoming Player text input. The logic of the AI Server 336 is configured to select responses based on the appropriateness of Player input based on context, content, delivery, timeline and language. This can include interpreting user motions and body language (Body Language Recognition (BLR)) that are captured by one or more camera or video capture units, and sending responses to the simulation application 310. Non-limiting examples of suitable software for assisting this process are described in greater detail below. For example, the aspects of the disclosed embodiments are configured to enable the user to correct their physical posture as it is being presented on by the avatar on the screen of the display. For example, in one embodiment, the user can touch the avatar or a suitable control on the display in order to correct or improve the posture that is being presented on the display. Alternatively, in one embodiment, the BLR component can be configured to recognize changes in player posture and make recommendations for improvement to the Player. For example, the BLR software may view the posture of the player through the device camera and may then make suggestions for changes. Alternatively, the player may view his or her avatar's posture, and may make changes independently. In either case, preferably scoring and feedback adjustments are made in response. The correction-or lack of correction-of the posture can also be used as part of the scoring component. The AI server 336 can also be configured to score all player input.

AI server 336 selects a response to send to the simulation, responding to the analyzed user input. This response is sent to simulation application 310, and also to account server 340, in order to support communication with the user through the website, as supported by website server 332. Simulation application 310 also optionally communicates with account server 340, to support communication with the user as part of the account simulation. Alternatively, simulation application 310 interacts with AI server 336 bi-directionally, and AI server 336 handles all responses to the user input, including those directed by simulation application 310.

The content server 338 is configured to house content for multiple simulations. In one embodiment, the content server 338 can house content for multiple substantially, different and simultaneously executed simulations. Thus, the aspects of the disclosed embodiments will enable the system to run simulations for different companies at the same time.

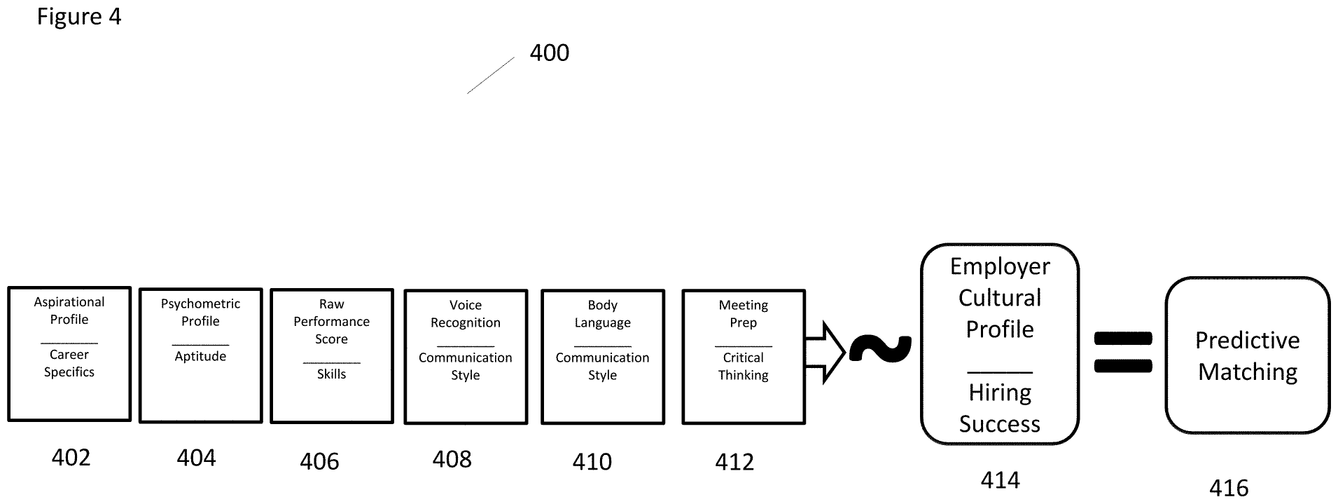

Referring to FIG. 4, the aspects of the disclosed embodiments are configured to provide predictive matching between players and employers, in an exemplary process 400. In one embodiment, the platform 300 of FIGS. 2 and 3 is configured to scan the Player profile preference and behavioral data, game scores, Employer profile data and interview/hire/success results data to make increasingly accurate predictive matches between Players and Employers.

Proprietary Machine Learning Algorithm: The platform 300 of the disclosed embodiments is configured to learn from user input and hiring-success-data for an increasingly immersive, responsive and predictive experience over time. For example, the platform 300 can be configured to analyze everything on both profiles, Player actions & voice in the game and hiring success to make matches.

For example, in process 400, preferably the player enters information through platform 300 (not shown, see FIG. 3), for example in a game or gamified interaction process. Such information is then analyzed as user input, to assist in matching the player (user) to the best employer and position for that player. The player input optionally and preferably includes an aspiration profile 402, with a plurality of career specifics, to assist matching based upon the career goals and desired employment location and type of the player. The player input also preferably includes a psychometric profile 404, featuring aptitude measurements, for example through the administration of a test (whether as a standardized test or in a gamified manner). The player input also preferably includes one or more Raw Performance Scores 406, related to measuring the level of one or more user skills, again for example through the administration of a test (whether as a standardized test or in a gamified manner). A voice recognition and analysis process 408 preferably assists in determining a communication style, for example through analysis supplied by AI server 336. A visual body language analysis process 410 preferably assists in determining a visual communication style, for example through analysis supplied by AI server 336. One non-limiting example of a technology for supporting such a process is the Millie product of 20BN (“https://” “20bn” “.com/”). A meeting preparation analysis process 412 preferably determines the degree of player readiness for a meeting as presented in a gamified manner.

This information is preferably analyzed to form a plurality of features for example in a process 414, to assist in matching to a plurality of employer and role features. Preferably the employer features include features related to employer culture and cultural fit—that is, to cultural or culture fit criteria, which may be used to match employees in an objective manner. The analysis and matching may be supplied by AI server 336. Such an analysis may be performed for example with regard to the employee analysis products of Pymetrics, which also relate to company culture and to other important metrics for matching (“http://” “www.” “pymetrics.” “com/”). A predictive matching output 416 then matches prospective employees (players) to employers, for example through a process performed by AI server 336.

Some of the advantages and benefits of the aspects of the disclosed embodiments include, but are not limited to:
a. For the players: Better matching with employers for more successful results.
b. A more responsive and personalized playing experience.
c. More accurate and broader representation of their skill set leading to better job matching.
d. More granular Post-Game feedback. This can include for example, scoring of a player based on their performance, as well as providing coaching feedback.
e. In one embodiment, the player will be able create or receive a recorded replay, such as a video replay, of the game meetings and the player's performance. The replay can be made available for other's to view and comment on. This can include posting the recording on a social interface. The aspects of the disclosed embodiments can allow for the player to select who will be able to view and/or comment.

For the Employers:

a. Allows them to conduct more granular searches.

b. A more accurate assessment of the talent.

c. A more accurate match.

d. More accurate view of the demographics of successful matches.

e. Improved profile content and performance.

For the Sponsors and Advertisers:

a. More refined data profile of players and employers

For the Platform:
a. Increased ability to target new players.
b. Increased revenue through improved value for in-app purchases such as the Post-Game Roundup.
c. Continuously modified and improved content for a better user experience.

The aspects of the disclosed embodiments can provide different user experiences, depending upon whether the user is a player or an employer. The networked and online aspects of the disclosed embodiments enable the system to achieve at least the above benefits and advantages, which cannot be realized in a prior art structure.

Player

Player Pre-Game Platform Experience

Players Create a Profile: To differentiate themselves from other competitors, players use their mobile or personal computing device to connect with the Content Server 338 and create a profile.

The aspects of the disclosed embodiments enable players to use their device 210A-210N to walk through the process of creating their personal brand and profile. In one embodiment the aspects of the disclosed embodiments can provide a software wizard for enabling the player to:
a. Create a personal message.
b. Create a personal video message (Make sure you're dressed for the job you want, speak loud and clear, close up, no distractions.)
c. Take a professional-looking photo.
d. Video interview signup through, for example, a WePow™ Affiliate Partner.
e. Create an online professional personal brand profile. In some cases this can be similar to commercially available online professional profiles,
f. Engage in a Behavioral/Aptitude Assessment game. The aspects of the disclosed embodiments can be configured to embed the “questions” into gamified content and make it part of the entire experience. In this manner, the user's focus can be redirected to solving the problems presented (instead of just answering questions) for a more accurate result. Such gamified content, and/or the analysis thereof, may be obtained from third party sources.

Players focus their job search using the software wizard of the disclosed embodiments on:
a. Thinking about their sales career (Helps them think about what kind of company, city, industry, service, etc. they want to sell for)
b. Thinking about their sales job (Helps them think about the type of sales job they want—inside sales, field sales etc.)
c. Resume writing. In one embodiment, the system is configured to provide a resume template that can be filled out by the user. For example, in one embodiment, a “resume wizard” can be provided that will guide the user through the process of developing a resume. This has the benefit making the format of all of the resumes the same and gives the student a best in class resume they can print. In one embodiment, employers can receive or otherwise obtain a PDF version they can run through their existing keyword search recruiting software.

Players can make their scores (the results of the game play or interaction) visible at least four different levels:
a. Free Agents: these players want their scores to be visible to all employers.
b. Industry Hunters: these players want their scores visible to companies in specific industries they are interested in.
c. Company Fans: these players want their scores to be visible to specific companies they want to work for.
d. Job Hunters: these players select sales positions posted by Employers that they want to compete for based on salary, responsibilities, experience, location, company size, number of candidate slots, etc. (Winners are guaranteed an interview for the job they've chosen.)

In one embodiment, the aspects of the disclosed embodiments can limit the number of sales positions that a player can select. For example, a player may be limited to selecting up to 10 sales positions to compete for.

In-App Player purchases are available via a link to affiliate partners to, for example, but not limited to:

a. Resume building services

b. Video resume services.
It will be understood that affiliate partners can provide any one of a number of suitable services related to the aspects of the disclosed embodiments.

Player functionality:

a. Link to App Store to download game

b. Create an account (via Social or email login)

c. Create/edit/view profile

d. Complete resume template form (see example above)

e. Watch proprietary videos and other multimedia content

f. Search for employer and job postings with 5 filters including company name, etc.

g. View employer profiles

h. View job postings

i. Save/Submit position choices

j. Current Competition view (how many players are competing for each position)

k. Players select up to 10 jobs to compete for

l. View leaderboard (post-game) with display filters

m. In-platform scripted messaging with Employers (post-game)

n. Receive notifications on platform via pop-ups

Player Post-Game Platform Experience

Immediately following the close of the simulation, players access the RNMKRS global leaderboard which will show their username, score, and location.

Players are encouraged to return for a next session, such as the following night for example, for the RNMKRS Ultimate Career Match-Up and the live unveiling of the RNMKRS job board that shows which players won interviews and with which companies. Make their simulation content available for viewing and commenting by other registered Players (see example described above)

In-App Player purchases are available via link to affiliates for:
a. Get coaching and feedback to enhance your job-hunting skills via the RNMKRS Post-Game Roundup of Players' performance in the simulation.
b. RNMKRS Sales Career Booster video series for $X includes how to dress, how to interview, etc.
c. Live interview coaching (Affiliate partner example: The Muse)

Sponsorship opportunities include, but are not limited to:

a. Global Leaderboard

b. RNMKRS Ultimate Career Match-Up

c. RNMKRS Post-Game Roundup report

d. RNMKRS Sales Career-Booster video series

Employer

Employer Platform Pre-Game Experience

Employers compete for top talent by using their mobile or personal computing device to connect to the Content Server to create a competitive company profile, including employee testimonials, product videos, core values, picture gallery, company facts, top customers, and finally the sales positions they are looking to fill.

The aspects of the disclosed embodiments can provide a setup featuring one or more wizards on:
a. Creating their company profile/marketing their company.
b. Use wizards that tells them how to appeal to millennials, boomers, etc.)
c. Creating the video
d. Creating their gallery
e. Creating employee testimonials
f. Creating e.g. a company profile. The company profile could also include corporate culture information
g. Creating Company Fact Sheet
h. Creating an effective Practice Pitch and why to create it (A test of player's ability to pitch the company's product.)

Employers enter hiring criteria for each sales position including, for example, but not limited to:

a. Salary range

b. Vacation

c. Benefits

d. Requirements/experience

Employers enter RNMKRS criteria:
a. Companies can choose to interview up to 10 players per sales position.
b. Companies can also elect to view scores and profiles from players interested in their industry or company.
c. Companies can pay extra to view scores and profiles of high-scoring players who have not necessarily shown interest in their company.

Employer Levels of Participation:
a. Level 1—Targeted Access: Companies can view scores from players interested in their industry, company and/or specific job posting.
b. Level 2—Universal Access: Targeted Access plus the ability to view all player scores and profiles.

In-App Employer purchases are available to:
a. Pre-test candidates' selling skills via RNMKRS Services Partner Practice Pitch.
b. Show in-game employer branding ads that appear throughout the competition
c. Conduct winning interviews in person, on the phone, or via RNMKRS service partner.

Player Post-Game Platform Experience

Immediately following the close of the simulation Employers will have access to a RNMKRS global leader board which will show player's username, score, and location.

Employers are encouraged to return for the next session, such as the following night, for the RNMKRS Ultimate Career Match-Up and the live unveiling of the RNMKRS job board that shows which players won interviews.

Employers go to their profile screen to see which players won interviews for the sales positions they posted and get exclusive access to those players' email addresses to set up interviews.

Employers can expand their access to include all players on the RNMKRS global leader board and get access to their contact information, such as email addresses or other social media contact, for example.

In-App employer purchases are available to:
a. Broaden their search: employers can purchase more players to interview for each sales position.
b. Get feedback on how to enhance their company profile

Employer Platform Functionality includes enabling an employer to:

a. Create an account

b. Create/edit/view profile

c. Add/edit/delete job posting(s)

d. View leaderboard (post-game) with display filters

e. View player profiles (post-game)

f. In-platform scripted messaging

g. Receive notifications on platform via pop-ups

The aspects of the disclosed embodiments can include a Platform Administrator.

The functionality of the Platform Administrator can include, but is not limited to, enabling an administrator to:

a. Create and delete accounts

b. Moderate accounts

c. Add/delete company profiles, job listings & player profiles

d. Send on-platform notifications and emails to players and companies

e. User analytics dashboard

f. Turn leaderboard on/off and view with filters

g. Delete players from leaderboard/change player's score

h. In-platform text chat with players and employers

Machine Learning/Data Output

Proprietary algorithm scans:

Player Profile Preference Data (job/company type, geography, salary)

Player Profile Behavioral/Aptitude Data (output of their behavioral assessment)

Player Raw Simulation Score (how they scored in the simulation)

Player Input Transcripts (voice to text transcriptions)

Player Simulation Behavior (how they proceeded through the simulation)

Player Profile Behavior (complete/incomplete)

Player Voice Input Tone—via device microphone

Player Body Language—via device camera and BLU software

Individual Player success at a matched employer

Aggregate Player profiles for matching with individual employers

Optionally, the above features regarding Player Body Language are determined through analysis of such body language for a plurality of Players, combined with determining a later success of one or more of such Players at an employer. For example, such a determination may relate to cultural fit at a company.

The aspects of the disclosed embodiments are configured to combine this output data into a composite index number that compares Player performances.

In one embodiment, the data can be visualized in 3D for Employers.

The following is an overview of Sales Simulation Game

Technology
a. In one embodiment, Players can for example, download the RNMKRS app from app stores. In alternate embodiments, the software can be obtained by the device in any suitable manner.
b. The software is installed on the device in any suitable manner.
c. The player uses the device to play the simulation
d. The player can interact with characters in the simulation with voice input enabled by the device microphone or any suitable voice input device.
e. In one embodiment, the device is configured to transcribe voice files into text transcripts.
f. The device can be configured to sends text transcripts of voice data to a cloud-based A/I server via WiFi, a voice data connection or other suitable link or network connection.
g. The A/I server is configured to scan the text for keywords/features
h. The content server is configured to classify the text.
i. The content server is configured to score the classified text.
j. The content server is configured to keep score of all Players
k. The content server is configured to select correct response-direction for device based animation and audio file from an inventory of responses on the content server.
l. The content server is configured to transmit response-direction to the device
m. The device is configured to receive response-direction from Content Server
n. The device is configured to play an appropriate animation and audio file

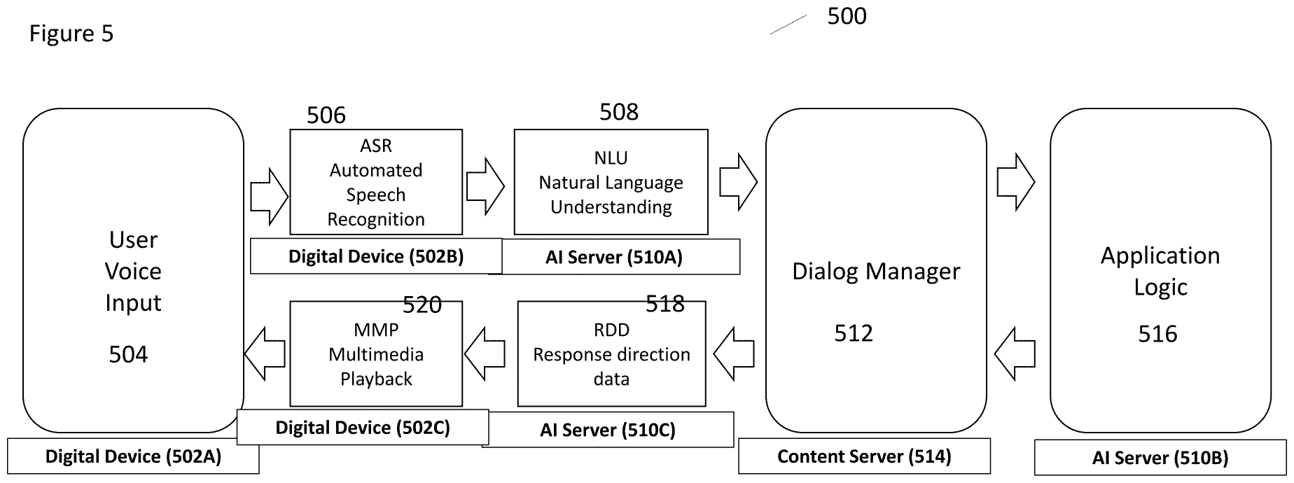

FIG. 5 illustrates an exemplary spoken language framework that can be used in conjunction with aspects of the disclosed embodiments. As shown in a flow 500, a digital device 502A receives user voice input 504, for example through a microphone. Digital device 502A may comprise a user computational device, including but not limited to a laptop computer, a desktop computer, a smart phone, a cellular telephone, a mobile device, a voice recorder and the like, as well as a simple audio recorder. A plurality of digital devices 502A-502D are shown; these may be the same or different types of digital devices, and may also be the same or different device.

User voice input 504 is then fed to an ASR (automated speech recognition) module 506, which is shown as being operated by digital device 502B. ASR module 506 is preferably the same for all users, using various digital devices 502. ASR module 506 then converts the speech of the user to text, which is sent to an AI server 510A for natural language understanding (NLU) 508. NLU 508 may operate according to any suitable NLP (natural language processing) algorithm, including without limitation an external service such as Amazon Comprehend. The analysis provided by NLU 508 is then preferably fed to a dialog manager 512, for example as operated by a content server 514. Dialog manager 512 preferably includes at least a number of rules and set dialog segments, thereby enabling a response to be provided to the content of user voice input 504, as analyzed by NLU 508. Dialog manager 512 preferably selects a dialog segment according to a rule, wherein the rule is selected according to the analyzed content of user voice input 504.

Further assistance in selecting an appropriate dialog segment may be made by an application logic module 516, which is supported by an AI server 510B. AI server 510B may the same or a different server than AI server 510A. Application logic module 516 may for example comprise a trained neural net for determining which rule is to be selected for selection of the dialog segment.

The dialog segment is then returned to digital device 502D, preferably through a response direction data (RDD) module 518. RDD module 518 preferably operates with natural language processing, to determine what was said, when it was said, how it was said, and its contextual accuracy based on its proximity to the desired response. RDD module 518 then determines the optimal response from the NPC. RDD module 518 is therefore operated by an AI server 510C. AI servers 510A-510C may be the same or different servers. That response is played to the user, and the conversation and scoring proceed.

The dialog segment is then played back to the user, for example as text or as audio, through a playback module 520, which is operated by digital device 502C. The cycle then continues as the user provides further user voice input 504.

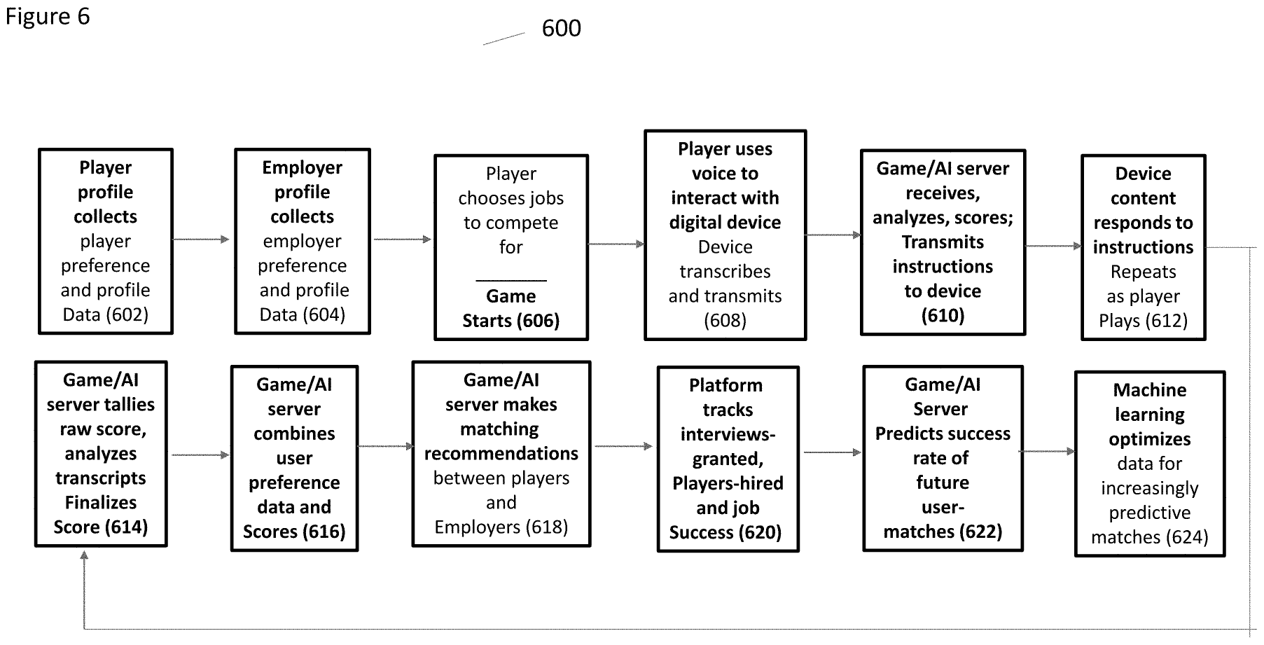

FIG. 6 illustrates an exemplary Player Data Process Flow during a sales game simulation according to the aspects of the disclosed embodiments. As shown in a process 600, at 602, a player profile module collects player preference and profile data as described above. At 604, an employer profile collects employer preference and profile data as described above. At 606, a player chooses jobs to compete for and the game starts. The game may be played according to the below described Player Simulation Experience. At 608, the player uses voice to interact with digital device. This device then transcribes the voice data to text and transmits the text to a previously described AI server. The transcription may be performed with art known software.

At 610, the AI server receives the transmitted text, representing the input of the player. The AI server analyzes and scores the input, for example according to the rules of the game, or according to a previously defined checklist to which the input should conform. For example, such a checklist preferably includes a determination of the appropriate content, in comparison to what was actually said; as well as a comparison to how the input was said, when it was said in the designated timeline of the simulation and its proximity to the desired response. The comparison to this checklist then results in a score, which is defined by a scoring rubric. The score rubric is preferably divided into topics and subtopics, each with its own point value assignment.

As a non-limiting example, the AI server may perform the following functions. The AI server preferably supports a RNMKRS conversation system, which listens for the seller's voice input, converts that input into text and then analyzes that text in order to determine and play the most appropriate audio response and animation. This determination is based on multiple factors including:
Where in the selling process timeline we are. Eg: Discovery vs Closing.
Whether or not the input matches various process criteria. Eg: Did the salesperson's input overcome the buyer's current objection.
Whether or not the seller's input is correct. Eg: The buyer's child plays baseball, not soccer.
Whether or not the seller input matches various communications criteria
Whether or not the seller input matches various empathy/trust criteria

In order to make these and other determinations correctly and respond appropriately, the conversation structure consists of a Timeline, Acts/Sub-acts and Omnis, all overlaid with a Scoring system. Preferably the conversation structure is analyzed and also scored by the AI server, for example according to the examples described herein.

Timeline

The entire conversation is preferably run by a timeline that ticks away from start to end. The clock continues even if the game is paused. The game starts with the Buyer defining the scope of the meeting—For example, “Welcome to Engine Company 23. Just to let you know. I've got a meeting with Homeland Security, so I'll need to keep this meeting under 10 minutes.” At the one minute mark the Buyer says: “Ok—we need to wrap this up I have a hard stop in one minute.” 10 seconds from the very end the Buyer says: “OK—well thanks for coming in I really do have to go now—my assistant will show you out.” The Buyer in this example is preferably a NPC (non-player character), whose dialog and image are synthesized as described herein.

Acts/Sub-Acts

There are five Acts, one for each of the steps in the sales process. An Act contains all of the buyer responses that are appropriate for that step in the sales process. The Acts are numbered 10, 20, 30, etc. in order to allow room for Sub-Acts to be numbered 22, 24, etc. as needed.

The conversation moves from Act 10: Building Rapport to Act 20: Discovery and so on. This helps place voice input into the context of the process so it can be determined if the input is appropriate and respond accordingly. For example, if the process is in Act 10 and the seller's input is about product presentation, the system knows that it's out of sequence and can say something like “Slow down. We'll get to that.”

The Buyer will move the flow from Act to Act, again through the previously described NPC presentation. For example, at the end of Rapport “OK, great—so, what do you have for me here today?” leading into Discovery questions from the Seller.

There are Sub-Acts. These are for organizational purposes. For example, in Act 40, if there are multiple objections and each have many buyer responses around it, it is cleaner to put all of those responses into a Sub-Act, such as Act 42, 44, etc.

Omnis

Omnis are buyer responses to Seller input that can be appropriate in multiple acts. For example, “Slow down. We'll get to that.” is a global response because it can be appropriate in multiple acts. Another example is something like “I beg your pardon?” for input that is insulting or inappropriate. Or, for input that the system doesn't understand—perhaps the player mumbled or for some reason the input was not recognized by the device—the buyer might say “Not sure I understand you. Say again.”

Each of these Omnis will have multiple variations to make the conversation feel more natural. For example, there can be “Slow down. We'll get to that.” and “Don't put your cart before your horse.” etc.

Some of the Omnis will have counters. For example, if the seller is out of sequence once, the buyer might say “Slow down. We'll get to that.” but if the seller keeps on doing this, after the third time, the buyer might say “How many times do I have to say this? Keep on track.”

Some sub-categories of Omnis are:
Business comments
   Seller Bragging Good: “Dell is rated #1 in Customer Satisfaction”.
Personal comments
   Seller Insulting Buyer
   Seller complimenting buyer subtly
Irrelevant comments
Out of sequence comments

Scoring

Scoring is preferably present within the whole structure. Some scoring is related to mandatory events and some is related to non-mandatory events. Think of it as the Olympics where are things that the athletes have to do and there are style points. Mandatory events that are hit out of sequence may receive partial credit.

Mandatory events may include:

In Act 2, did the seller determine the relevant facts about the company/Buyer

In Act 4, did the Seller get clarification on the stated objections

Non-Mandatory events include:

Is the Seller polite?

Is the Seller using a lot of filler words?

Is the Seller talking too much and not listening to the Buyer?

Is the Seller making irrelevant comments?

Scoring display includes:

Total Score—Numerical

Sales Process Steps—Numerical
Rapport
   4 mandatory steps—Pass/Fail
Discovery
   7 mandatory steps—Pass/Fail
Product Presentation
   1 mandatory step—Pass/Fail
Overcoming Objections
   3 mandatory steps—Pass/Fail
Closing
   2 mandatory steps—Pass/Fail
Communications—Numerical
   3 mandatories—Pass/Fail
Trust—Numerical
   4 mandatories—Pass/Fail

Preferably, a wide range is available in the scoring so that there is a meaningful difference between scores, for example, on the bottom quarter of the leaderboard and those on the top quarter. Optionally the bottom 20% is generated with bots (that don't have profiles), for example to avoid giving the perception of “losing” rather than of learning.

The AI server then transmits instructions back to the user device, for example in the form of dialog back to the user, for example as being performed by an NPC (Non-Player Character).

At 612, the new dialog or other content is displayed back to the user through the user device. Steps 608-612 are then preferably repeated at least once, and optionally multiple times as the game is played.

At 614, the AI server tallies the raw score. Scores from individual responses are scored as described above. These individual response scores are then combined into a point total that is supplemented by data from the simulation timer, including, for example, how long the player has to respond and how much time elapsed. This supplemented point total forms a composite score, which may be weighted against the composite scores of other players in the cohort.

The AI server optionally further analyzes transcripts and then finalizes the raw score. Once the AI server has the raw score, it preferably analyzes the transcripts to determine a second level of scoring variables in relation to a plurality of heuristics. These heuristics include but are not limited to how many filler words the player included, how many words were spoken by the user versus the amount of words spoken by the NPC, whether the player pauses to listen, and so forth. The AI server then combines these values with the composite score for a final simulation score.

At 616, the AI server combines user preference data and scores, to determine which matches would be a best fit for the user (player). At 618, the AI server makes matching recommendations between players and employers according to the combined user preference data and scores, and input from the employers about the success rates of players previously matched with them.

At 620, the account server tracks interviews-granted, players-hired and job success. The account server receives information from the employers regarding interviews, hired players (new employees) and their rated success. The Account Server may for example reach out to employers at 3, 6 and 9 months out to poll the success of player employer matches. The AI Server analyzes player-related data, their scores, their completion of tasks (did they register, did they practice, did they watch the training videos). Based upon the account server tracking data, the AI server predicts success rate of future user-matches at 622. Machine learning (ML) optimizes data for increasingly predictive matches at 624, for example through various algorithms operated by the AI server. For example, the AI server may use K Means Clustering ML to form increasingly predictive matches about where future players will have the most sales success and where employers will find the sales candidates most likely to succeed at their company.

The aspects of the disclosed embodiments create and provide a Player Simulation Experience where the Player, represented by an avatar presented on their device 210A-210N, interacts with an NPC (Non-Player Character) during the simulated sales exercise. When the game starts, the player chooses their avatar. Any suitably configured avatar can be selected or used.

In one embodiment, the game has three Levels, all played against the clock:
a. Level 1: In a simulated setting on the player device, meet a departing sales person and ask the questions needed to meet the sales objective.
b. Level 2: Collect and prioritize important information needed to achieve their sales objective.
c. Level 3: Meet with the client and compete using interactive dialog to meet the sales objective

Level 1—In Your Office: Getting Briefed on the Client and Sales Objective (timed)

In this part of the game, the Player meets, in a simulated meeting with an AI driven, animated bot, representing a co-worker who has been working with the client. The simulated meeting is presented on the display or user interface of the player(s) device 210A-210N. The co-worker presents the Player with a challenge at the key account that the Player will be involved with going forward.

The sales objective in each episode will be different. Example sales objectives include, but are not limited to:

a. We've been trying to close a deal for months, but we can't.

b. We haven't been able to get on the consideration list for a large product.

c. We haven't been able to cross-sell another product.

Level 1 Objective: Ask your co-worker the right questions to find out the background information you will need to do your research, meet with the client and attempt to meet your sales objective.

Example Meeting Content: You get a call from your boss. He tells you that a co-worker, sales representative has failed to meet her sales goals and today is her last day. She knows your company has the perfect solution for the client, but she can't get the client to replace their current vendor with your company. You will be attending a meeting with the client and taking over the account. The meeting starts in thirty minutes. The boss tells you to go talk to the co-worker. Do your best to get the information you need in an interactive interview with her. The co-worker, an AI bot, appears on your video conferencing window. An example of this is shown in FIG. 6. She (the AI bot) will respond to your input including content choices and tone of voice.

In this example, the co-worker will give you this information unsolicited:

a. The company's name

b. The business they're in

c. The client's name/title

d. Their position in the market

Using the microphone or other input device on your device 210A-210N, such as a text input, you ask the co-worker questions to get important additional information, such as for example:
a. What that company is trying to do/achieve: their objective.
b. The objective of the sales meeting with the client
c. Background/account history: How many times the co-worker has met with the client. What the results of the meetings were.
d. Co-worker's thoughts on next steps: “Bill talked about two potential approaches. You'll have to talk with him and see which way makes most sense for him.”
e. Co-worker's insight into the client budget: “I don't think they're looking to spend more than $100,000, but that's a guess because if they're given the right solution they might spend a lot more because it's very important to their strategy.” This is another set up for you to figure out what their strategy is and how you could get them to spend more if that is the stated sales objective.
f. Co-worker's insight into potential competitors: “They seem interested in working with us, however I happen to know a competitor, ABC Solutions, is also pitching him.”
g. Co-worker finally tells you to get to work and prepare for the meeting.

Level 2—In Your Office: Research and Preparation (30 minutes timed)

The Player uses information gathered in Level 1 to help discover additional information needed to prepare for the meeting with the client.

Level 2 Objective: Use your sales instincts to uncover key information that you will use at the meeting with the client.

To succeed at the game, you will need to research, for example:
a. The company: What their strategy is. What they've done in the past. Some information on the size of the projects from the past. The culture of the company.
b. The company's competition: Their strategy and their history of projects/executions.
c. The client: Connections you may share with him, what his interests are, what his business history is, business associations he belongs to, how long he's been at the company, etc.
d. The competition: understand what they offer, what they charge, what their strengths and weaknesses are
e. Executions in the client's industry by way of comparables

As you uncover data points in your research, they will unlock more information that will help you succeed at the game.

Level 3—The Meeting (timed). Although certain time periods and durations are associated with the Levels 1-3 herein, the aspects of the disclosed embodiments are not so limited. In alternate embodiments, the different levels and aspects of the disclosed embodiments can have any suitable time periods or durations.

In this level, Player meets with the client and attempts to meet the sales objective.

Level 3 Objective: Use your forensic and presentation skills to have a successful meeting.

This level simulates an actual sales meeting. Like in an actual sales meeting, what you say and how you say it and how you—the player—present yourself will lead to a better or worse outcome. In this level, you will be scored on your performance in the meeting:
a. Your content: the questions you ask, things you say, your responses to the client, etc.
b. Your tone of voice
c. Your body language (as depicted by your avatar's animated motions)

Meeting Dynamic:

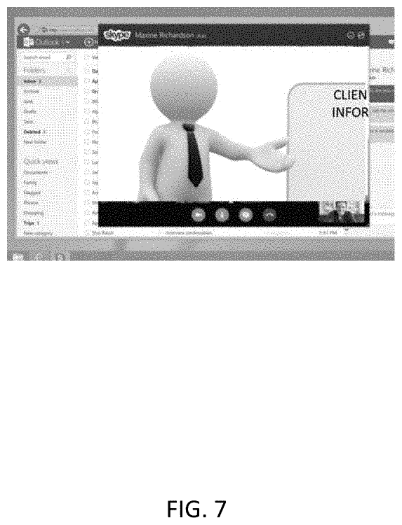

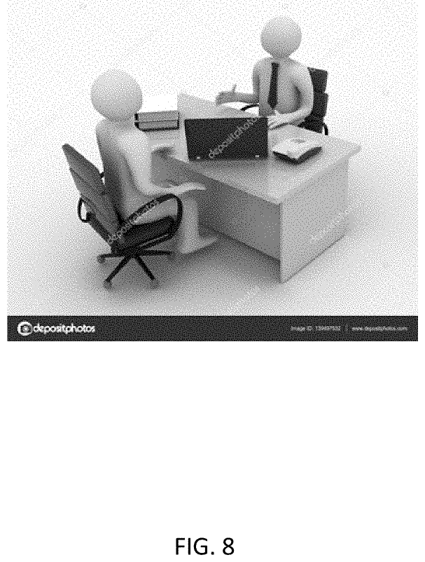

An example of a simulated meeting is shown in FIGS. 7 and 8. FIGS. 7 and 8 illustrates an exemplary display on the user interface of the device 210A-210N of the simulation. You, as the player, meet with the client, represented by an NPC (Non Player Character), via your avatar. You control what your avatar says to the client by speaking into the microphone on or connected to your device. The avatar will present what you say in a manner that may or may not be appropriate for maximum sales effectiveness. You will need to modify inappropriate presentation to increase your score. For example, you ask an excellent question, but in an inappropriate tone and with “mallspeak”, which may include filler words that are considered to be inappropriate and/or unproductive. Tone is detected by a third party waveform analysis plug-in, a non-limiting example of which is the tone analyzer service of Watson of IBM (“https://” “www.” “ibm.” “com” “/watson/services/tone-analyzer/”). The resultant data is sent from the app to the AI server for analysis, response direction and scoring. The aspects and system of the disclosed embodiments are configured to be able to interpret the tone of the words spoken. When an inappropriate tone such as “mallspeak” is detected, the aspects of the disclosed embodiments will configure to reflect this in the Player's score. And, in this exemplary situation, the avatar will deliver the speech while slouching in the chair. You will lose points for the mallspeak and have three seconds to stop the action and tell your avatar to sit up straight for partial presentation credit.

As noted above, the aspects of the disclosed embodiments are configured to interpret voice and cause a suitable reaction and change in the avatar. For example, the client is an animated AI bot responding to the player's input with (dialog branches) and body language. You begin a line of questioning that shows that you are not up-to-speed on the client's business strategy. The client bot will respond by crossing his arms looking frustrated and taking you down a suboptimal dialog path. This sequence of events are represented in the Player's score.

Simulation Scoring Overview

Salesperson Evaluation: Detecting key characteristics of high-performing sales people. These characteristics include, but are not limited to:

Communication Style
a. Body Language, as captured by one or more cameras connected to or coupled to the device.
b. Verbal Language, as captured by one or more microphone or other communication input devices connected to or coupled to the device.
c. Speaking Tone, as captured by one or more microphone devices connected to or coupled to the device.

Effective verbal communication skills (active listening: restated, rephrased, clarify, probed for better understanding)

Verbiage (clear, concise, professional), natural presentation, ability to connect with buyer as captured by one or more microphone devices connected to or coupled to the device.

Technical Selling Skills: the Player's ability to structure the meeting as follows, for example:

a. Approach (Effectively gain attention and build rapport)

b. Professional introduction

c. Effectively build rapport and gains the client's attention

d. Transition into Discovery phase

Discovery (Obtain a clear understanding of customer's situation in order to prepare a customized presentation)
a. Uncover decision process (decision criteria, people involved, timing and budgetary issues)
b. Effectively determine relevant facts about the company and/or buyer
c. Effectively gain a basic understanding of the prospect's problems, challenges and/or goals
d. Ask effective questions that brought to the buyers' attention what happens to the company or the buyer when the problems continue or if the issue is resolved (to help the buyer see the value of a solution)

Gain a pre-commitment to consider the product/service and smooth transition to presentation.

Product/Service Presentation (Persuasively match your product or service's benefits to meet needs of buyer)
a. Brief overview of the company and potential solution to build credibility to gain the next appointment
b. Impactful and memorable value proposition that ties-in the value of the solution to the unique needs of the client

Overcoming Objections (Eliminate concerns or questions to customer's satisfaction)

Initially gain better understanding of objection (clarify or allow buyer to clarify objection)

Effectively answer objections, ensures the concern has been addressed and is no longer a concern of the buyer.

Close (Take initiative to understand where you stand with the buyer now and for the future)

Persuasively ask for business or appropriate commitment from the buyer, given the nature of the call.

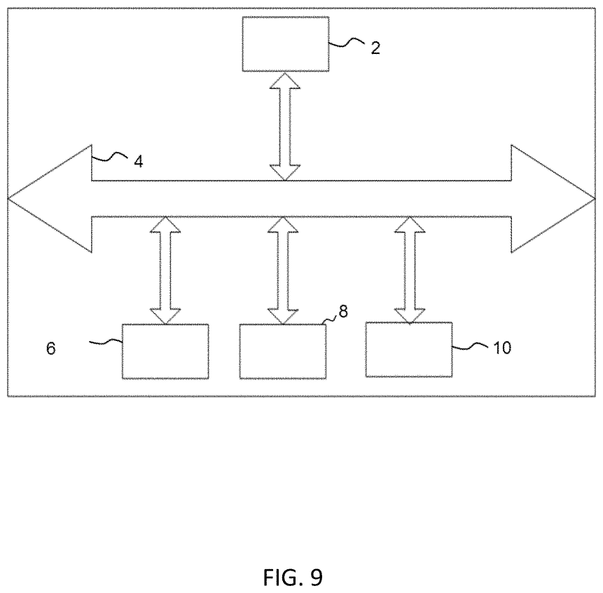

Referring to FIG. 9, illustrated is an exploded view of a computing architecture that can be used to practice aspects of the disclosed embodiments. In this example, the computing architecture includes a memory 2 having a set of instructions, a bus 4, a display 6, a speaker/microphone 8, and a processor 10 capable of processing the set of instructions to perform any one or more of the methodologies herein, according to an embodiment herein. The processor 10 may also enable digital content to be consumed in the form of video for output via one or more displays 6 or audio for output via speaker and/or earphones 8. The processor 10 may also carry out the methods described herein and in accordance with the embodiments herein. In one embodiment, the computing architecture is part of, or coupled to, one or more of the devices 210A-210N.

Digital content may also be stored in the memory 2 for future processing or consumption. A user may view stored information on the display 6 and select an item of for viewing, listening, or other uses via input, which may take the form of keypad, scroll, or other input device(s) or combinations thereof. The content and stored information may be passed among functions within the computing architecture using the bus 4.

The computing architecture includes a user interface, when supporting interactions with the user. As used herein, a “user interface” generally includes a plurality of interface devices and/or software that allow a user to input commands and data to direct the processing device to execute instructions. For example, the user interface may include a graphical user interface (GUI) or an interface to input computer-executable instructions that direct the processor to carry out specific functions. The user interface employs certain input and output devices to input data received from a user or output data to a user. These input and output devices may include a display, mouse, keyboard, button, touchpad, touch screen, microphone, speaker, LED, light, joystick, switch, buzzer, bell, and/or other input/output device for communicating with one or more users or participants in the sales simulation.

Processor 10 performs instructions for operating the computational device including with regard to the user interface. Such instructions are stored in the memory 2. As used herein, a processor generally refers to a device or combination of devices having circuitry used for implementing the communication and/or logic functions of a particular system. For example, a processor may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processor may further include functionality to operate one or more software programs based on computer-executable program code thereof, which may be stored in a memory. As the phrase is used herein, the processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

For example, for the functions of the AI server, instructions from memory 2 are executed by processor 10 to support these functions, such as an NLP analysis module. For this example, processor 10 comprises a hardware processor configured to perform a predefined set of basic operations in response to receiving a corresponding basic instruction selected from a predefined native instruction set of codes, that are stored on memory 2. For example, processor 10 may execute instructions stored in memory 2, in which the latter comprises a first set of machine codes selected from the native instruction set for receiving input from the user (provided as output from the user computational device), a second set of machine codes selected from the native instruction set for operating the NLP analyzer module for decomposing the output from the user computational device, and a third set of machine codes selected from the native instruction set for scoring the output from the user computational device.

Optionally a fourth set of machine codes selected from the native instruction set executes the NLP analyzer module for combining a plurality of scores from a plurality of decomposed outputs, and for forming a raw score from the combined plurality of scores, and from a length of time between provision of outputs and a total time elapsed during said simulation of said sales session.

Optionally a fifth set of machine codes selected from the native instruction set supports execution of functions by the AI server to analyze transcripts of said sales session to to determine a second level of scoring variables in relation to a plurality of heuristics, wherein the heuristics are selected from the group consisting of a number of filler words, a number of words provided in said decomposed output, and a number and length of pauses.

Optionally a sixth set of machine codes selected from the native instruction set supports execution of functions by the AI server for combining the raw score with the second level of scoring variables to determine a final simulation score.

Optionally, a seventh set of machine codes selected from the native instruction set is operated by a processor for executing a simulation application, for simulating a sales session (for example, by a processor reading codes from a memory of a simulation server). Optionally an eighth set of machine codes selected from the native instruction set is operated by a processor for executing a rules based engine of said simulation application, for selecting a dialog segment according to a rule.

Optionally a ninth set of machine codes selected from the native instruction set is operated by a processor for executing the NLP analyzer module, for determining which rule from the simulation application is invoked by the decomposed output.

The embodiments herein can take the form of, an entirely hardware embodiment, an entirely software embodiment, or an embodiment including both hardware and software elements. The embodiments that are implemented in software include but are not limited to, firmware, resident software, microcode, scripts, etc. Furthermore, the embodiments herein can take the form of a computer program product accessible from a computer-usable or computer-readable medium providing program code for use by or in connection with a computer or any instruction execution system. For the purposes of this description, a computer-usable or computer-readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, remote controls, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

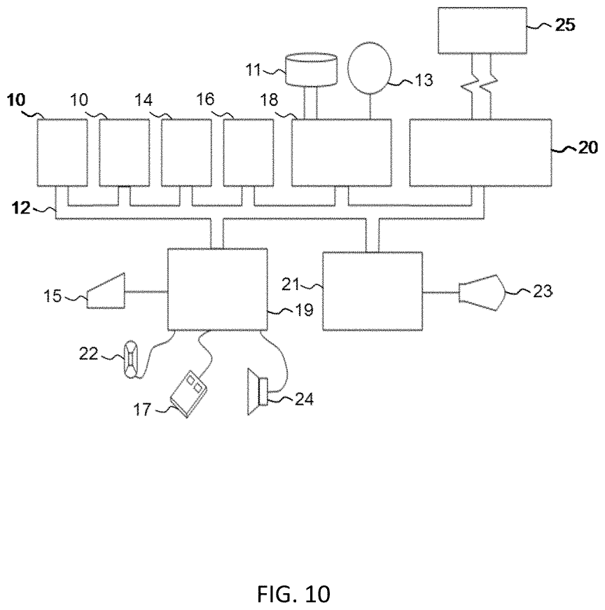

Another representative hardware environment for practicing the embodiments herein is depicted in FIG. 10. This schematic drawing illustrates a hardware configuration of a computer architecture/system used to implement one or more of the aspects of the disclosed embodiments. The hardware configuration can include one or more of the devices 210A-210N. The system comprises at least one processor or central processing unit (CPU) 10, such as the processor 10 also shown in FIG. 9. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein.

The system further includes a user interface adapter 19 that connects a keyboard 15, mouse 17, speaker 24, microphone 22, camera and/or other user interface devices such as a touch screen device (not shown) or a remote control to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

Thus, while there have been shown, described and pointed out, fundamental novel features of the invention as applied to the exemplary embodiments thereof, it will be understood that various omissions, substitutions and changes in the form and details of devices and methods illustrated, and in their operation, may be made by those skilled in the art without departing from the spirit and scope of the presently disclosed invention. Further, it is expressly intended that all combinations of those elements, which perform substantially the same function in substantially the same way to achieve the same results, are within the scope of the invention. Moreover, it should be recognized that structures and/or elements shown and/or described in connection with any disclosed form or embodiment of the invention may be incorporated in any other disclosed or described or suggested form or embodiment as a general matter of design choice.

What is claimed is:

1. A system for matching a user to an employer according to a plurality of criteria, the system comprising a user computational device for receiving input from, and displaying output to, the user; a simulation computational device for operating a simulation application, wherein said simulation application simulates a sales session; and an AI server for analyzing output from the user computational device and for providing input to the user computational device during simulation of said sales session; wherein said AI server receives the plurality of criteria and said output from the user computational device, and scores said output from the user computational device; said AI server then selects input according to said simulation application and according to said output from said user computational device, and sends said input to said user computational device, to support said simulation of said sales session; wherein a match is determined by said AI server at a close of said sales session.

2. The system of claim 1, wherein said AI server further comprises an NLP (natural language processing) analyzer module for decomposing said output from the user computational device; wherein said simulation application comprises a rules based engine and a plurality of dialog segments; wherein said NLP analyzer module determines which rule from said simulation application is invoked by said decomposed output, and selects a relevant dialog segment according to said rule; wherein said relevant dialog segment is returned to said user computational device for display.

3. The system of claim 2, wherein said simulation application further comprises a game application for simulating a non-player character (NPC) for participating in said simulated sales session; and wherein said NPC is displayed to deliver said relevant dialog segment on said user computational device.

4. The system of claim 2, wherein said NLP analyzer module compares said decomposed output to said plurality of criteria and determines a score for said decomposed output according to said comparison; wherein said comparison further comprises a determination of the appropriate content in comparison to a content of said decomposed output; a determination of how and when said decomposed output was provided in the designated timeline of the simulation.

5. The system of claim 4, wherein said decomposed output is provided a plurality of times and wherein said AI server determines a raw score from a combination of individually scored decomposed outputs, and from a length of time between provision of outputs and a total time elapsed during said simulation of said sales session.

6. The system of claim 5, wherein said AI server analyzes transcripts of said sales session to determine a second level of scoring variables in relation to a plurality of heuristics, wherein said heuristics are selected from the group consisting of a number of filler words, a number of words provided in said decomposed output, and a number and length of pauses; wherein said AI server combines said raw score with said second level of scoring variables to determine a final simulation score.

7. The system of claim 6, wherein said AI server receives user preference data regarding employment, and combines said user preference data and said final simulation score, to determine a match with an employer.

8. The system of claim 7, wherein said AI server further receives employer preference data regarding employment, and determines said match also according to said employer preference data.

9. The system of claim 8, wherein said AI server receives employer information regarding interview decisions and hiring decisions, and updates said heuristics and said comparison of said decomposed output to said plurality of criteria according to said employer information.

10. The system of claim 9, wherein said AI server further predicts a likelihood of success of matching to the employer, according to said updated heuristics and said updated comparison.

11. The system of claim 10, further comprising a content server for supplying content to said simulation application; wherein said dialog segments are further selected by said AI server from said content provided by said content server.

12. The system of claim 11, wherein said AI server further comprises a hardware processor and a memory, wherein said processor is configured to perform a predefined set of basic operations in response to receiving a corresponding basic instruction selected from a predefined native instruction set of codes, wherein said codes are stored on said memory, wherein said codes comprise a first set of machine codes selected from the native instruction set for receiving said output from the user computational device, a second set of machine codes selected from the native instruction set for operating the NLP analyzer module for decomposing the output from the user computational device, and a third set of machine codes selected from the native instruction set for scoring the output from the user computational device.

13. The system of claim 12, wherein said memory on said AI server further comprises a fourth set of machine codes selected from the native instruction set for executing said NLP analyzer module for combining a plurality of scores from a plurality of decomposed outputs, and for forming a raw score from the combined plurality of scores, and from a length of time between provision of outputs and a total time elapsed during said simulation of said sales session.

14. The system of claim 13, wherein said memory on said AI server further comprises a fifth set of machine codes selected from the native instruction set for supporting execution of functions to analyze transcripts of said sales session to determine a second level of scoring variables in relation to a plurality of heuristics, wherein the heuristics are selected from the group consisting of a number of filler words, a number of words provided in said decomposed output, and a number and length of pauses.

15. The system of claim 14, wherein said memory on said AI server further comprises a sixth set of machine codes selected from the native instruction set for combining the raw score with the second level of scoring variables to determine a final simulation score.

16. The system of claim 15, wherein said simulation server further comprises a hardware processor and a memory, wherein said processor is configured to perform a predefined set of basic operations in response to receiving a corresponding basic instruction selected from a predefined native instruction set of codes, wherein said codes are stored on said memory, wherein said codes comprise a seventh set of machine codes selected from the native instruction set for executing said simulation application, for simulating a sales session.

17. The system of claim 16, wherein said memory of said simulation server further comprises an eighth set of machine codes selected from the native instruction set for executing said rules based engine of said simulation application, for selecting a dialog segment according to a rule.

18. The system of claim 17, wherein said memory of said AI server further comprises a ninth set of machine codes selected from the native instruction set for executing the NLP analyzer module, for determining which rule from the simulation application is invoked by the decomposed output.

19. The system of claim 18, wherein said criteria are selected from the group consisting of skills based criteria, body language criteria, tone criteria and culture fit criteria.
